(19) United States
(12) Patent Application Publication
(10) Pub. No.: US 2016/0088678 A1
(43) Pub. Date: Mar. 24, 2016

(54) NETWORK INITIATED EVOLVED PACKET CORE (EPC) AND IP MULTIMEDIA SUBSYSTEM (IMS) NETWORK USAGE OPTIMIZATION ALGORITHM FOR LTE CAPABLE SMARTPHONES CONNECTED TO WIRELESS LAN (WI-FI) NETWORK

(71) Applicant: Telefonaktiebolaget L M Ericsson (publ), Stockholm (SE)

(72) Inventor: SRINIVASAN SRIDHARAN, Bellevue, WA (US)

(21) Appl. No.: 14/494,122

(22) Filed: Sep. 23, 2014

(51) Int. Cl. H04W 76/04

(52) U.S. Cl. CPC H04W 76/046; H04L 2012/6459

(57) ABSTRACT

According to some embodiments, an LTE node determines that a wireless device is in radio resource control (RRC) idle mode and starts an inactivity timer Tw. In response to expiry of the inactivity timer Tw, the LTE node directs the wireless device to a legacy node.

### TECHNICAL FIELD

Particular embodiments relate generally to wireless communications and more particularly to optimizing network usage for LTE capable devices connected to a wireless LAN (Wi-Fi) network.

### BACKGROUND

Wireless devices and radio access networks communicate according to a radio access technology (RAT). Examples of radio access technologies include long term evolution (LTE), wireless local area network (Wi-Fi), code division multiple access (CDMA), wideband CDMA (WCDMA), and/or global system for mobile communications (GSM). Some devices support multiple radio access technologies. These devices may attach to more than one radio access technology at a time. For example, because Wi-Fi access points are widely deployed in homes, offices, coffee shops, airports, gyms, and so on, LTE capable devices are often attached to both the Wi-Fi network and the LTE network. Wi-Fi network resources may be used to send and receive data, and LTE network resources may be used for Periodic Tracking Area Updates or other overhead signaling.

During the times that a device uses Wi-Fi resources for sending and receiving data, the device may be idle with respect to the LTE network. In this situation, managing overhead signaling for the device makes for non-optimal use of LTE resources. This problem tends to compound as the number of devices attached to the LTE network increases. The use of smartphones and other wireless devices has tremendously increased in recent years and will likely continue to increase in the future. Estimates suggest that by the year 2020, the number of connected devices may be around 50 billion. Given the number of devices to be served, it is becoming increasingly important to optimize the allocation of network resources to help ensure that active users receive high data throughputs.

### SUMMARY

According to some embodiments, an LTE node determines that a wireless device is in radio resource control (RRC) idle mode and starts an inactivity timer Tw. In response to expiry of the inactivity timer Tw, the LTE node directs the wireless device to a legacy node. Examples of the legacy node may include a node that uses one of the following radio access technologies: code division multiple access (CDMA), wideband CDMA (WCDMA), or global system for mobile communications (GSM). In some embodiments, to direct the wireless device to the legacy node, the LTE node sends the wireless device a redirect message that includes a target frequency used by the legacy node.

In some embodiments, the LTE node determines that the wireless device has entered RRC connected mode prior to expiry of the inactivity timer Tw. In response, the LTE node stops the inactivity timer Tw. The LTE node may reset the inactivity timer Tw to its initial value, such as a value between 5 and 15 minutes. If the wireless device enters RRC idle mode, the LTE node restarts the inactivity timer.

According to some embodiments, a legacy node receives a first radio resource control (RRC) connection request from a wireless device. The first RRC connection request indicates inter radio access technology reselection as its cause. The legacy node does not direct the wireless device to an LTE node in response to receiving the first RRC connection request. The legacy node receives a second RRC connection request from the wireless device. The second RRC connection request indicates origination of packet data traffic as its cause. In response to receiving the second RRC connection request, the legacy node directs the wireless device to the LTE node. The legacy node may connect a voice call for the wireless device after receiving the first RRC connection request and prior to receiving the second RRC connection request.

According to some embodiments, a wireless device is attached to an LTE node. The wireless device determines that Wi-Fi is on and that the wireless device is not in a voice over LTE (volte) call or a video call with an LTE node. The wireless device then starts a Wi-Fi ping session via a Wi-Fi node. If the Wi-Fi ping session is successful and no packet loss is observed, the wireless device detaches from the LTE node, disables LTE, and attaches to a legacy node. In some embodiments, the wireless device determines the legacy node using one or more of frequency assignment, preferred roaming list (PRL), or public land mobile network (PLMN) information indicated by a subscriber identity module (SIM) of the wireless device. While the wireless device is attached to the legacy node, the wireless device may receive voice services from the legacy node and packet data services from the Wi-Fi node.

In some embodiments, the wireless device determines that Wi-Fi has been disconnected or packet loss has occurred on the Wi-Fi connection. In response, the wireless device detaches from the legacy node, enables LTE, and attaches to the LTE node. In some embodiments, the wireless devices stops the Wi-Fi ping session if the Wi-Fi is disconnected or if packet loss is observed on the Wi-Fi ping session.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example of a network according to some embodiments;

FIG. 2 is a flow chart illustrating an example embodiment of a network-initiated method of optimizing network usage of an LTE-capable wireless device connected to a Wi-Fi network;

FIGS. 3A-3B provide a signal diagram illustrating an example embodiment of a network-initiated method of optimizing network usage of an LTE-capable wireless device connected to a Wi-Fi network;

FIG. 4 is a flow chart illustrating an example embodiment of a wireless device-initiated method of optimizing network usage of an LTE-capable wireless device connected to a Wi-Fi network;

FIGS. 5A-5B provide a signal diagram illustrating an example embodiment of a wireless device-initiated method of optimizing network usage of an LTE-capable wireless device connected to a Wi-Fi network;

FIGS. 6A-6B are block diagrams illustrating example embodiments of a wireless device; and

FIGS. 7A-7B are block diagrams illustrating example embodiments of a network node.

### DETAILED DESCRIPTION

As described above, certain wireless devices may be capable of attaching to both a Wi-Fi network and an LTE network. These devices may use Wi-Fi resources for sending and receiving data and may remain idle with respect to the LTE network. In a conventional LTE network, the network manages LTE overhead signaling even for idle devices. This approach consumes LTE network and backhaul network resources that could otherwise be allocated to active LTE data users. As a result, active LTE data users may get less than optimal throughput from the LTE network.

Certain embodiments of the present disclosure may optimize resource allocation for LTE capable wireless devices. In some embodiments, optimization may be initiated by the network. For example, the LTE network detects when a wireless device is connected and using a Wi-Fi network. The LTE network redirects the wireless device from the LTE network to a legacy radio access network, such as a CDMA, WCMDA, or GSM network depending on the capabilities of the wireless device and/or the capabilities of the legacy radio access network. The legacy radio access network may provide voice services to the wireless device and the Wi-Fi network may provide data services to the wireless device.

In some embodiments, if the wireless device gets disconnected from the Wi-Fi network and attempts to use the legacy radio access network for data services, the legacy radio access network node redirects the wireless device to the LTE network. For example, if the wireless device sends the legacy radio access network a PS service request message, the legacy radio access network may respond with a release with redirect to the LTE network.

In some embodiments, optimization may be initiated by the wireless device. For example, a wireless device connected to and successfully sending/receiving/syncing data with a Wi-Fi network detaches from the LTE network, disables LTE on its baseband modem, and attaches to the legacy radio access network. If the wireless device gets disconnected from the Wi-Fi network or detects a packet loss, the wireless device detaches from the legacy radio access network, enables LTE on its baseband in the modem, and attaches to the LTE network.

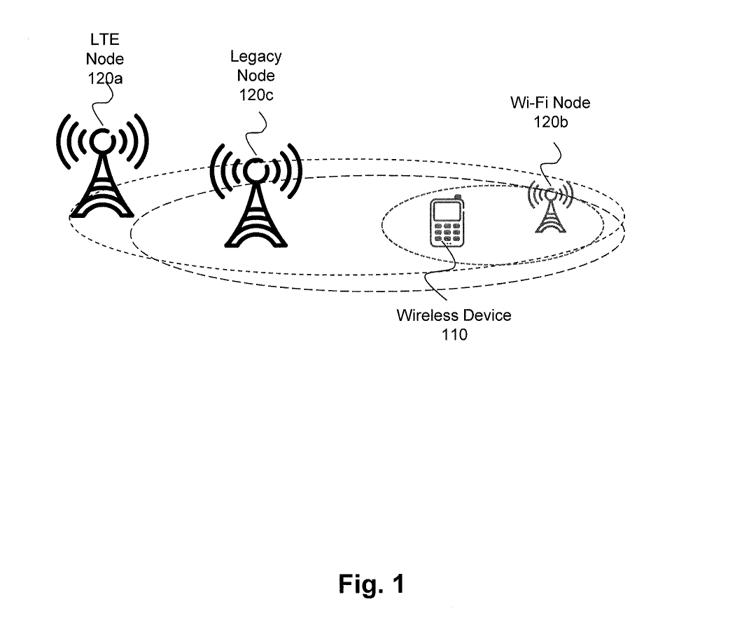

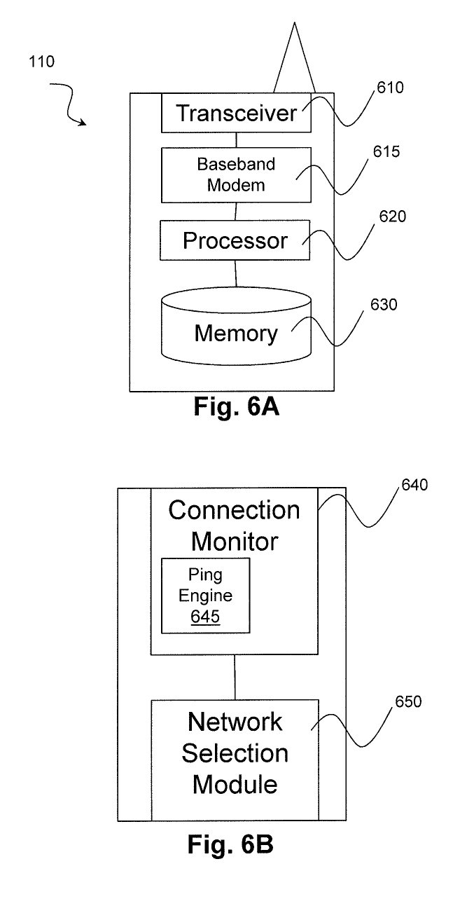

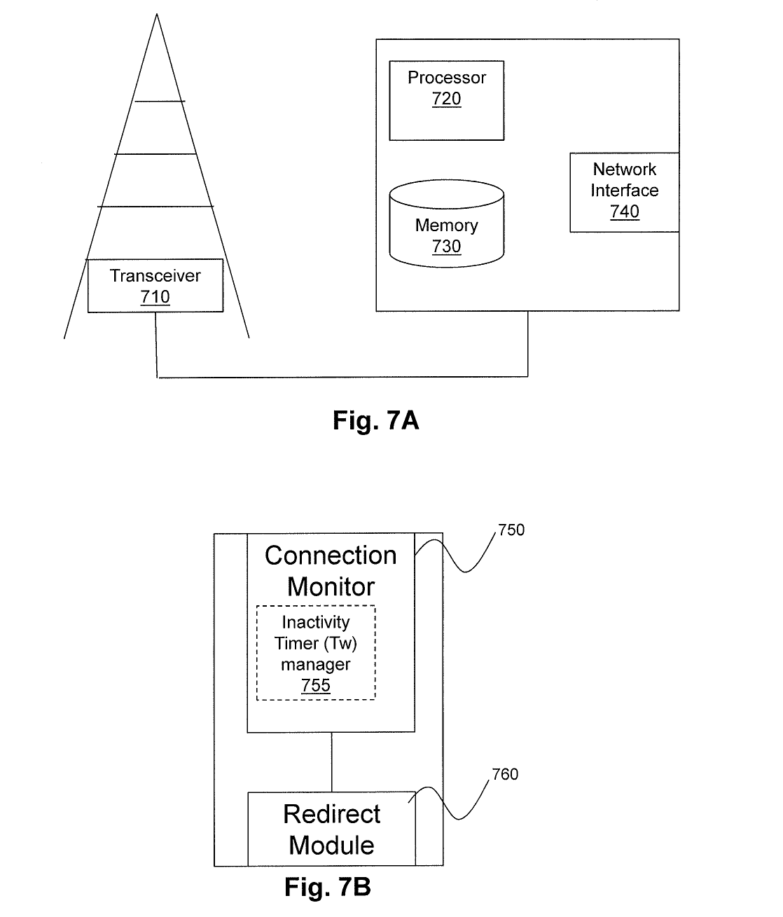

FIG. 1 is a block diagram illustrating an example of a network according to some embodiments. The network includes one or more wireless device(s) 110 and a plurality of network nodes 120. In general, a wireless device 110 and a network node 120 communicate signals containing voice traffic, data traffic, and/or control signals. Examples of wireless device 110 are further described with respect to FIGS. 6A-6B. Examples of network nodes 120 are further described with respect to FIGS. 7A-7B below and may include one or more LTE nodes 120a (e.g., an eNodeB), Wi-Fi nodes 120b (e.g., a WLAN access point, such as an IEEE 802.11 access point), and legacy nodes 120c (e.g., a CDMA, WCDMA, or GSM base station/radio network controller).

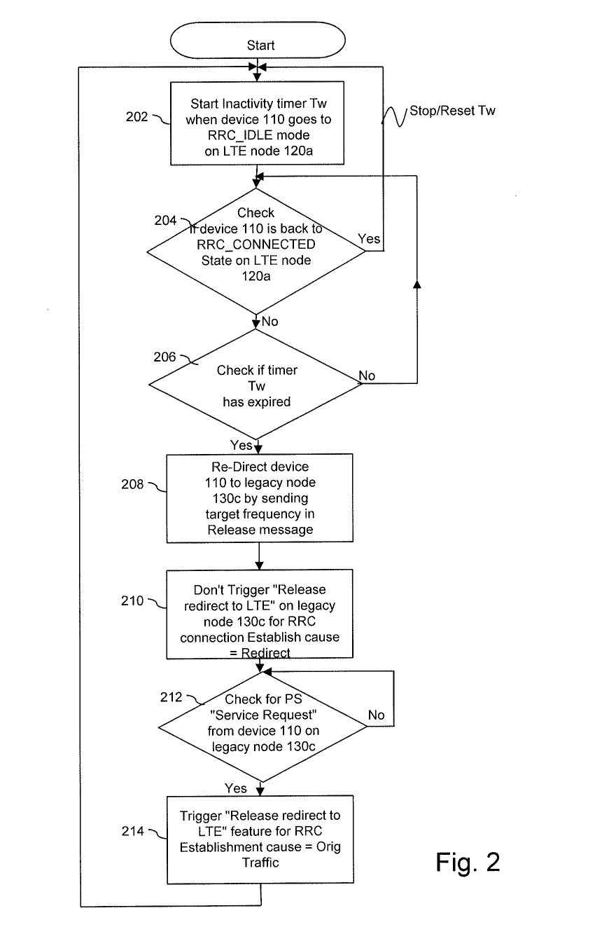

FIG. 2 is a flow chart illustrating an example embodiment of a network-initiated method of optimizing network usage of an LTE-capable wireless device connected to a Wi-Fi network. When the method begins, a wireless device 110 may be attached to an LTE node 120a. Wireless device 110 may be idle with respect to the LTE network. That is, wireless device 110 may be using the LTE network for certain overhead signaling, but wireless device 110 is not currently using the LTE network to perform a handover, data ping, data download, data upload, voice call, voice over LTE (volte) call, or similar functionality.

In general, LTE node 120a uses an inactivity timer Tw to monitor wireless device 110. The inactivity timer Tw may be set to any suitable value, such as a value between 5 and 15 minutes. If the inactivity timer Tw expires, LTE node 120a determines that there is sufficient likelihood that wireless device 110 is attached to a Wi-Fi node 120b and is therefore using Wi-Fi node 120b, rather than LTE node 120a, to send and receive data. This determination may be based on the assumption that a typical wireless device 110 regularly sends and/or receives data in order to refresh applications (“apps”) running on wireless device 110. For example, social networking applications, email applications, messengers, and/or other applications running on wireless device 110 may regularly contact their respective servers via the radio access network to fetch data and sync their contents. Thus, long periods of inactivity suggest that wireless device 110 is using another network to send/receive data. In response to expiry of inactive timer Tw, LTE node 120 directs wireless device 110 to a legacy node 120c so that resources of the LTE network may be conserved for active LTE users.

An example of the method summarized in the previous paragraph may begin at step 202 where LTE node 120a starts inactivity timer Tw when wireless device 110 goes to RRC_IDLE mode. At step 204, LTE node 120a checks if wireless device 110 is back to RRC_CONNECTED state on LTE node 120a. If at step 204 wireless device 110 is in RRC_CONNECTED state, LTE node 120a may stop inactivity timer Tw, reset inactivity timer Tw to its initial value (such as a value between 5 and 15 minutes), and return to step 202. If at step 204 wireless devices is not in RRC_CONNECTED state, the method may continue to step 206 where LTE node 120a checks if inactivity timer Tw has expired. If at step 206 inactivity timer has not expired, LTE node 120a returns to step 204. If inactivity timer Tw has expired at step 206, then the method continues to step 208.

At step 208, LTE node 120a redirects wireless device 110 to legacy node 120c. As an example, LTE node 120a sends a release message with target frequency information for a legacy network, such as a CDMA, WCDMA, or GSM network. The particular type of legacy network (e.g., CDMA, WCDMA, or GSM) may depend upon the capabilities of wireless device 110 and neighbor relations of LTE node 120a. Examples of neighbor relations may include proximity of the legacy network to LTE node 120a, current load on the legacy network, or operator status. For example, a network operator might choose try to redirect wireless device 110 to the operator's own legacy network ahead of another operator's legacy network.

In response, wireless device 110 moves to the legacy network and may send an RRC connection message to legacy node 120c with the “establishment cause” configured as “Inter RAT Reselection.” A location area update (LAU), routing area update RAU, and/or modify packet data protocol (PDP) context may be performed in connection with inter RAT reselection. Based on receiving the “Inter RAT Reselection” establishment cause in the RRC connection message, legacy network node 120c keeps wireless device 110 on the legacy network at step 210 and does not trigger a release with redirect back to LTE.

After moving to the legacy network, wireless device 110 may communicate with legacy node(s) 120c for voice calls. If wireless device 110 is in coverage of a Wi-Fi node 120b, wireless device 110 may communicate with Wi-Fi node 120b to send and receive data. If wireless device 110 experiences packet loss on the Wi-Fi network or gets disconnected from the Wi-Fi network (e.g., if the user turns off Wi-Fi capability or if wireless device 110 moves out of the Wi-Fi coverage area), wireless device 110 may attempt to set up a data session with legacy node 120c. For example, wireless device may send a “Packet-Switched (PS) Service request” to the Legacy packet switched core network via legacy node 120c. The PS Service request may have an RRC connection request Establishment cause of “Origination traffic.” The legacy network/legacy node 120c checks for the PS Service Request at step 212. If no PS Service Request is received, legacy node 120c continues handling voice traffic for wireless device 110 and assumes that Wi-Fi node 120b is handling the user and control plane for data traffic for wireless device 110. If a PS Service Request is received, the method continues to step 214.

At step 214, legacy node 120c triggers a release and redirect to the LTE network with Establishment cause set to “Origination traffic.” Thus, if the Wi-Fi network is unable to provide data services, wireless device 110 is directed back to the LTE network rather than having the legacy network provide the data services.

For simplicity, the previous example has described a single LTE node 120a as monitoring the inactivity timer Tw associated with wireless device 110. In some embodiments, multiple LTE nodes 120a may monitor this inactivity timer Tw. As an example, a first LTE node 120a(1) may start a five minute inactivity timer Tw when wireless device 110 is within coverage of first LTE node 120a(1). If wireless device 110 stays in idle mode and moves to coverage of a second LTE node 120a(2) after two minutes, second LTE node 120a(2) may continue monitoring inactivity timer Tw where first LTE node 120a(1) left off (with three minutes remaining) rather than having to restart inactivity timer Tw at the initial value of five minutes. Similarly, the previous examples has described a single legacy node 120c, however, multiple legacy nodes 120c may be involved in steps 210-214.

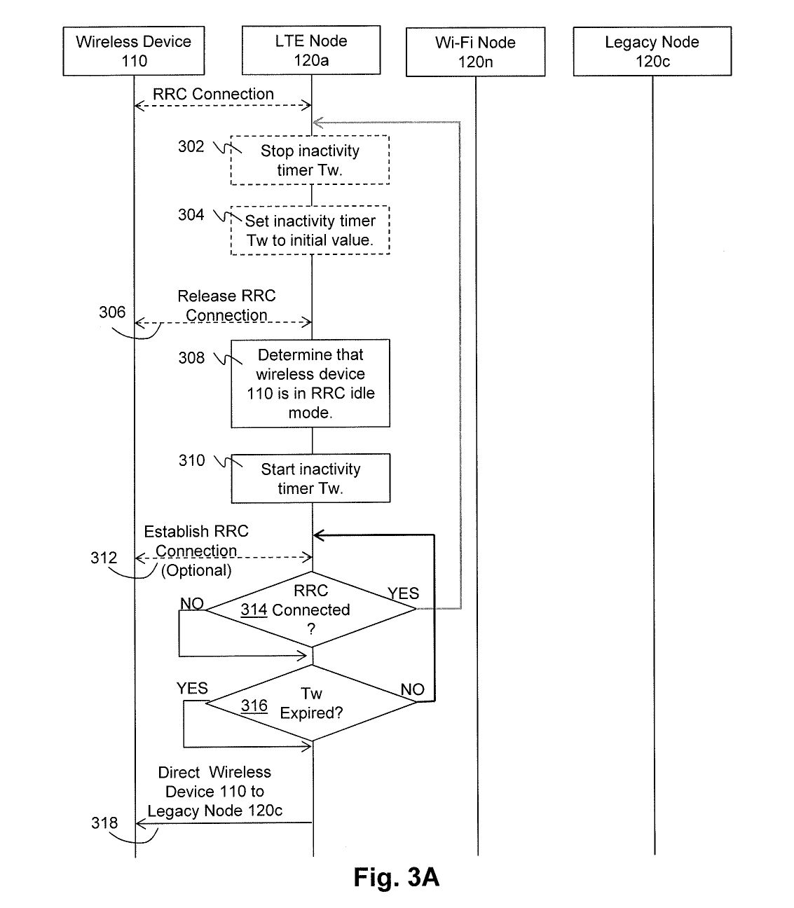

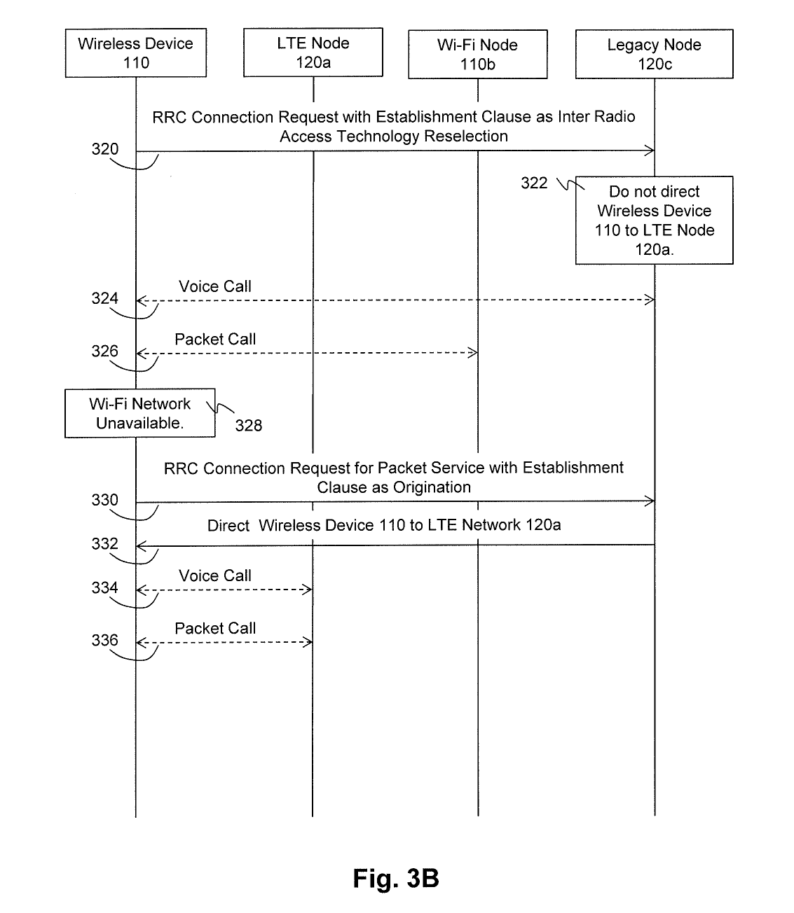

FIGS. 3A-3B provide a signal diagram illustrating an example embodiment of a network-initiated method of optimizing network usage of an LTE-capable wireless device connected to a Wi-Fi network. The method may begin with LTE node 120a handling traffic for wireless device 110. If inactivity timer Tw is running, LTE node 120a stops the inactivity timer at step 302 of FIG. 3A. For example, LTE node 120a may stop the inactivity timer Tw in response to receiving an RRC connection request. LTE node 120a may then set inactivity timer Tw to its initial value at step 304. Any suitable value may be configured as the initial value. In some embodiments, the initial value is between 5 minutes and 15 minutes. At step 306, the RRC connection between LTE node 120a and wireless device 110 is released. The connection may be released for any suitable reason, such as the user ending a voice call or upon completion of a data upload or download. In response to releasing the connection, LTE node 120a determines that wireless device 110 is in RRC idle mode (step 308) and starts inactivity timer Tw at step 310.

At step 312, wireless device 110 and LTE node 120a optionally establish an RRC connection prior to expiry of the inactivity timer Tw. As an example, if wireless device 110 is outside Wi-Fi network coverage, wireless device 110 may periodically connect with LTE node 120a to refresh email, social media, messengers, or other applications running on wireless device 110. At step 314, LTE node 120a determines if a connection request was received and/or if an RRC connection has been established between wireless device 110 and LTE node 120a. If yes, the method returns to step 302 where LTE node 120a stops inactivity timer Tw in response to the wireless device having entered RRC connected mode. LTE node 120a then resets inactivity timer Tw to its initial value at step 304. Once the RRC connection has been released (step 306), LTE node 120a determines that wireless device 110 has entered RRC idle mode at step 308. In response, at step 310 LTE node 120a restarts inactivity timer Tw from its initial value. If step 312 does not occur such that the optional RRC connection is not established, LTE node 120a determines that there is no RRC connection at step 314 and continues to step 316 to determine if inactivity timer Tw has expired. If inactivity timer Tw has not expired, LTE node 120a returns to step 314 to check for an RRC connection. If inactivity timer Tw has expired, LTE node continues to step 318.

At step 318, LTE node 120a directs wireless device 110 to a legacy node 120c in response to expiry of the inactivity timer Tw. In some embodiments, LTE node 120a directs wireless device 110 to legacy node 120c by sending wireless device 110 a redirect message that includes a target frequency used by legacy node 120c. As examples, the target frequency may be a frequency used by a legacy code division multiple access (CDMA) network, a legacy wideband CDMA (WCDMA) network, or a legacy global system for mobile communications (GSM) network. In some embodiments, LTE node 120a selects the target frequency based on the capabilities of wireless device 110 and/or the configuration of LTE node 120a's neighboring nodes. In some embodiments, wireless device 110 determines legacy node 120c from the frequency information. For example, wireless device 110 may determine legacy node 120c as the node from which it receives a good signal on the target frequency and without having to receive legacy node 120c's cell identifier from LTE node 120a.

Continuing to FIG. 3B, at step 320, wireless device 110 sends a first radio resource control (RRC) connection request to legacy node 120c. The first RRC connection request indicates inter radio access technology reselection as its establishment cause. In response, legacy node 120c keeps wireless device 110 on the legacy network and does not direct wireless device 110 to LTE node 120a at step 322. While wireless device 110 is attached to the legacy network and the Wi-Fi network, the legacy network handles voice calls (step 324) and the Wi-Fi network handles packet data calls (step 326) for wireless device 110.

At step 328, wireless device 110 may experience packet loss on the Wi-Fi network or may get disconnected from the Wi-Fi network (e.g., if the user turns off Wi-Fi capability or if wireless device 110 moves out of the Wi-Fi coverage area). In response, wireless device 110 may attempt to set up a data session with legacy node 120c. For example, wireless device 110 may send legacy node 120c a second RRC connection request at step 330. The second RRC connection request indicates origination of packet data traffic as its cause. In response, legacy node 120c directs wireless device 110 to LTE node 120a at step 332. For example, legacy node 120c directs wireless device 110 to a frequency associated with the LTE network and wireless device 110 selects an LTE node 120a from which it receives a good signal on that frequency. Thus, wireless device 110 may return to the original LTE node 120a or, if wireless device 110 has moved outside of coverage of the original LTE node 120a or radio conditions have changed, wireless device may select another LTE node 120a.

After being directed to the LTE network, LTE node 120a may handle any voice calls (step 334) and packet data calls (step 336) for wireless device 110. The method may return to step 302 and the steps of the method may be repeated so that if wireless device re-enters Wi-Fi coverage/becomes idle on the LTE network, wireless device 110 can be moved to a legacy network and LTE network resources may be conserved for non-idle LTE users.

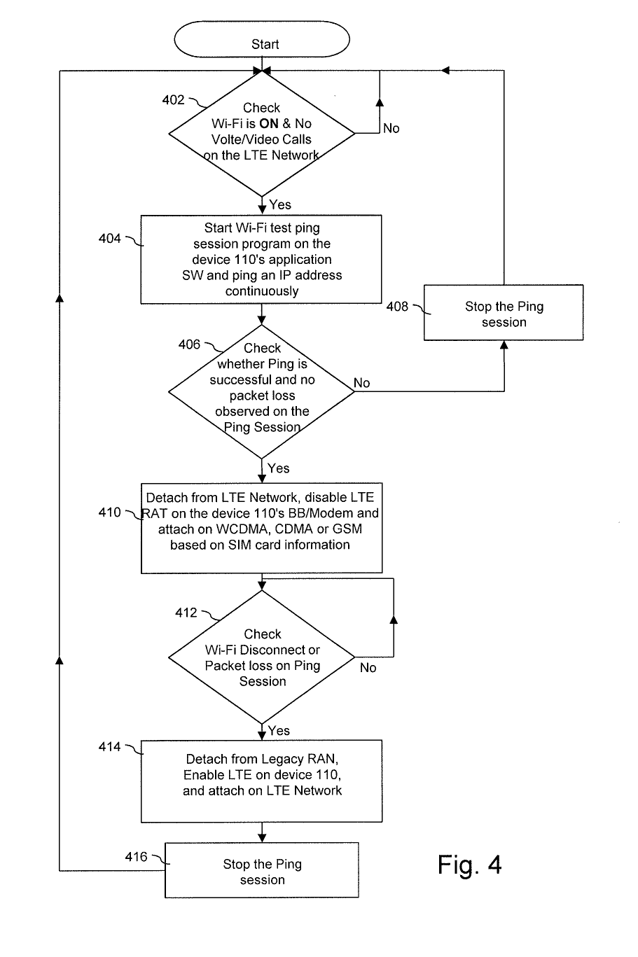

FIG. 4 is a flow chart illustrating an example embodiment of a wireless device-initiated method of optimizing network usage of an LTE-capable wireless device connected to a Wi-Fi network. In general, a wireless device 110 connected to an LTE network and a Wi-Fi network reselects from the LTE network to a legacy network. Wireless device 110 may then use the Wi-Fi network for packet data traffic and the legacy network for voice/circuit-switched traffic. If wireless device 110 disconnects from the Wi-Fi network or moves into a Wi-Fi dead zone, wireless device 110 detects and moves back to the LTE network.

The method begins at step 402 where wireless device 110 determines its Wi-Fi configuration and its call status. For example, wireless device 110 checks its application software to determine if Wi-Fi is ON or OFF. Wireless device 110 also checks if it is in a call with the LTE network, such as a voice over LTE (volte) call or a video call. Wireless device 110 repeats step 402 until Wi-Fi is ON and wireless device 110 has no ongoing call on the LTE network. Wireless device 110 then continues to step 404 to start a Wi-Fi test ping session. In some embodiments, wireless device 110's application software continuously pings an IP address, such as www.ericsson.com or any suitable IP address configured for the test ping session.

At step 406, wireless device 110 checks whether the ping is successful and no packet loss is observed. If the ping is unsuccessful or packet loss is observed, the method proceeds to step 408 to stop the ping session and return to step 402. In some embodiments, wireless device 110 may also initiate a timer at step 408 and may wait until the timer expires before returning to step 402.

If at step 406 the ping is successful and no packet loss is observed, the method proceeds to step 410 where wireless device 110 detaches from the LTE network, disables the LTE radio access technology on wireless device 110's baseband modem software, and attaches to a legacy network, such as a CDMA, WCDMA, or GSM network. In some embodiments, wireless device 110 determines the legacy network using a frequency assignment, preferred roaming list (PRL), and/or public land mobile network (PLMN) information indicated by a subscriber identity module (SIM) of wireless device 110. Because wireless device 110 will be using the Wi-Fi network for data traffic, it need only attach to the circuit switched core network and not the packet switched core network of the legacy network (e.g., no GPRS Mobility Management (GMM) attach).

After completing step 410, wireless device 110 may use the legacy network for voice/circuit switched traffic and the Wi-Fi network for packet data traffic. Using the legacy network for voice/circuit switched traffic rather than the LTE network during the times that wireless device 110 is able to use the Wi-Fi network for packet data traffic may reduce overhead signaling on the LTE network.

At step 412, wireless device 110 continues to check until Wi-Fi disconnect or packet loss on the Wi-Fi ping session occurs. If wireless device 110 experiences a Wi-Fi disconnect or packet loss, the method proceeds to step 414 where wireless device 110 detaches from the legacy network, enables the LTE radio access technology, and attaches on the LTE network. After completing step 416, wireless device 110 uses the LTE network for any voice or packet data traffic. The method may then return to step 402 so that wireless device 110 can eventually resume using the Wi-Fi network when the conditions permit it. In some embodiments, wireless device 110 may also initiate a timer at step 416 and may wait until the timer expires before returning to step 402.

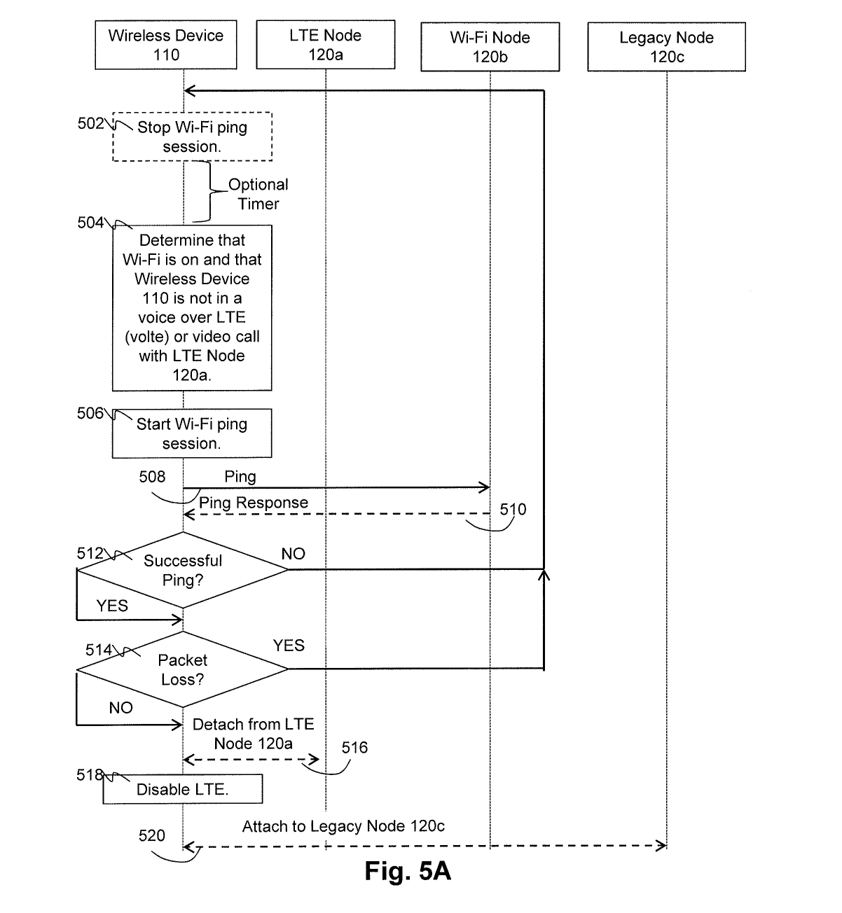

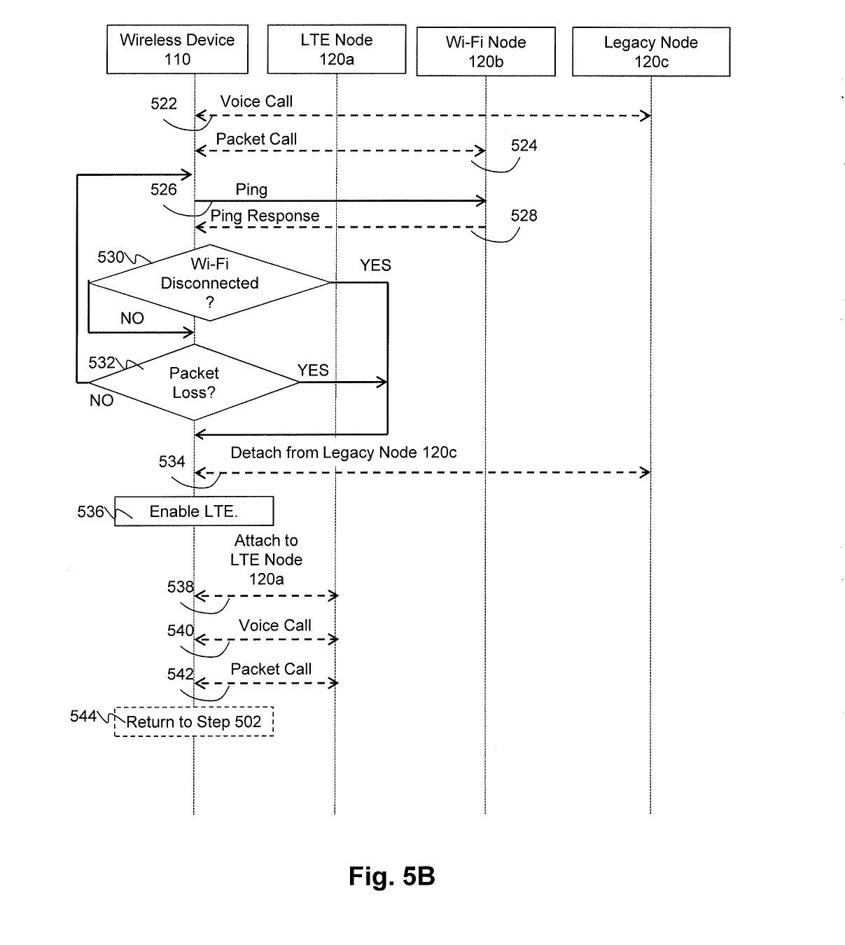

FIGS. 5A-5B provide a signal diagram illustrating an example embodiment of a wireless device-initiated method of optimizing network usage of an LTE-capable wireless device connected to a Wi-Fi network. The method begins at step 502 of FIG. 5A where, if a Wi-Fi ping session is in progress, wireless device 110 stops the Wi-Fi ping session. In some embodiments, wireless device 110 stops the Wi-Fi ping session if the user sets the Wi-Fi configuration to OFF, if wireless device 110 has a call in progress on the LTE network, or if packet loss has been observed on the Wi-Fi ping session.

When wireless device 110 stops the Wi-Fi ping session, it may optionally start a timer and may wait until expiry of the timer before proceeding to the next step. Thus, if wireless device 110 is located in a challenging Wi-Fi environment, it may be prevented from getting into a loop where it is constantly turning the ping session on and off Waiting for the timer to expire may allow time for wireless device 110 to move and/or for conditions to change such that retrying the ping sessions has a better likelihood of success.

At step 504, wireless device 510 determines that Wi-Fi is on and that the wireless device is not in a voice over LTE (volte) call or a video call with the LTE node. At step 506, wireless device 110 starts a Wi-Fi ping session and sends ping 508 via a Wi-Fi node 120b. At step 510, wireless device 110 optionally receives a ping response from Wi-Fi node 120b. Wireless device 110 uses the ping response to determine if the ping was successful and if packet loss was observed. If at step 512 wireless device 110 determines the ping was unsuccessful, then the method returns to step 502. If at step 512 wireless device 110 determines that the ping was successful, the method continues to step 514 where wireless device 110 checks for packet loss. If wireless device 110 observes packet loss, the method returns to step 502. If there is no packet loss observed, the method continues to step 516.

At step 516, wireless device 110 detaches from LTE node 120a. At step 518, wireless device 110 disables LTE. For example, wireless device 110 disables LTE on its baseband modem. At step 520, wireless device 110 attaches to legacy node 120c. In some embodiments, legacy node 120c is a CDMA node, a WCDMA node, or a GSM node. Wireless device 110 may determine legacy node 120c using one or more of frequency assignment, PRL, or PLMN information indicated by wireless device 110's SIM card. Wireless device 110 may attach to the circuit switched core of the legacy network without attaching to the packet core of the legacy network (e.g., no GMM attached) because wireless device 110 can receive packet data traffic from the Wi-Fi network.

Continuing to FIG. 3B, after detaching from the LTE network and attaching to the legacy network, wireless device 110 communicates voice traffic with one or more legacy nodes 120c (step 522) and packet data traffic with one or more Wi-Fi nodes 120b (step 524). During this time, the ping session may continue to run in the background so that wireless device 110 can determine if Wi-Fi becomes disconnected or if packet loss occurs. For example, wireless device 110 sends ping 526 and, if possible, receives ping response 528. At step 530, wireless device 110 determines if Wi-Fi is disconnected based on whether ping response 528 was received and/or based on any configuration changes made by the user (e.g., if the user turned off Wi-Fi). If Wi-Fi is still connected, wireless device 110 checks for packet loss at step 532. If wireless device 110 does not observe packet loss, it returns to step 526 to send another ping.

If at step 530 wireless device 110 determines that Wi-Fi was disconnected or if at step 532 wireless device 110 observes a packet loss, the method continues to step 534. At step 534, wireless device 110 detaches from legacy node 120c. At step 536, wireless device 110 enables LTE. For example, wireless device 110 enables LTE on its baseband modem. At step 538, wireless device 110 attaches to an LTE node 120a of the LTE network. LTE node 120a may be the LTE node that wireless device 110 was previously using or a different LTE node (e.g., if wireless device 110 moved locations or radio conditions changed). After attaching to LTE node 120a, wireless device 110 may use the LTE network to communicate any voice traffic (step 540) or packet data traffic (step 542). The method then returns to step 502 so that wireless device 110 can eventually resume using the Wi-Fi network when the conditions permit it.

FIGS. 6A-6B are block diagrams illustrating example embodiments of a wireless device 110. Examples of wireless device 110 include a mobile phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, or any other device that can provide wireless communication. Wireless device 110 may be interchangeably referred to as user equipment (UE) or a smartphone. FIG. 6A illustrates an embodiment where wireless device 110 includes transceiver 610, baseband modem 615, processor 620, and memory 630. In some embodiments, transceiver 610 facilitates transmitting wireless signals to and receiving wireless signals from network node 120 (e.g., via an antenna), baseband modem 615 enables/disables various radio access technologies and assists in interpreting/processing the wireless signals transmitted and received by transceiver 610, processor 620 executes instructions to provide some or all of the functionality described herein as provided by a wireless device 110, and memory 630 stores the instructions executed by processor 620.

Processor 620 includes any suitable combination of hardware and software implemented in one or more integrated circuits or modules to execute instructions and manipulate data to perform some or all of the described functions of wireless device 110. Memory 630 is generally operable to store computer executable code and data. Examples of memory 630 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Other embodiments of wireless device 110 include additional components (beyond those shown in FIG. 6A) responsible for providing certain aspects of the wireless device's functionality, including any of the functionality described above and/or any additional functionality (including any functionality necessary to support the solution described above).

FIG. 6B illustrates an example embodiment of a wireless device 110 that includes connection monitor 640, ping engine 645, and network selection module 650. The components of FIG. 6B may comprises any suitable hardware and/or software, such as any hardware and/or software described with respect to FIG. 6A. In some embodiments, connection monitor 640 determines that Wi-Fi is on and that wireless device 110 is not in a voice over LTE (volte) call or a video call with LTE node 120a. Ping engine 645 then starts a Wi-Fi ping session via Wi-Fi node 120b. If ping engine 645 determines that the Wi-Fi ping session is successful and no packet loss is observed, network selection module 650 detaches from LTE node 120a, disables LTE, and attaches to legacy node 120c. In some embodiments, network selection module 650 selects legacy node 120c using one or more of frequency assignment, preferred roaming list (PRL), or public land mobile network (PLMN) information indicated by a subscriber identity module (SIM) of the wireless device. In some embodiments, connection monitor 640/ping engine 645 determines that Wi-Fi has been disconnected or packet loss has occurred on the Wi-Fi connection. In response, network selection module 650 detaches from legacy node 120c, enables LTE, and attaches to LTE node 120a. In some embodiments, ping engine 645 then stops the Wi-Fi ping session.

FIGS. 7A-7B are block diagrams illustrating example embodiments of a network node 120. Network node 120 can be, for example, a radio access node, such as an eNodeB, a node B, a base station, a wireless access point (e.g., a Wi-Fi access point), a low power node, a base transceiver station (BTS), a transmission point or node, or a remote RF unit (RRU). FIG. 7A illustrates an embodiment where network node 120 includes at least one transceiver 710, at least one processor 720, at least one memory 730, and at least one network interface 740. Transceiver 710 facilitates transmitting wireless signals to and receiving wireless signals from wireless device 110 (e.g., via an antenna); processor 720 executes instructions to provide some or all of the functionality described above as being provided by a network node 120; memory 730 stores the instructions executed by processor 720; and network interface 740 communicates signals to backend network components, such as a gateway, switch, router, Internet, Public Switched Telephone Network (PSTN), other network nodes 120, and/or core network nodes. The processor 720 and memory 730 can be of the same types as described supra with respect to FIG. 6A.

In some embodiments, network interface 740 is communicatively coupled to processor 720 and refers to any suitable device operable to receive input for network node 120, send output from network node 120, perform suitable processing of the input or output or both, communicate to other devices, or any combination of the preceding. Network interface 740 includes appropriate hardware (e.g., port, modem, network interface card, etc.) and software, including protocol conversion and data processing capabilities, to communicate through a network.

Other embodiments of network node 120 include additional components (beyond those shown in FIG. 7A) responsible for providing certain aspects of the node's functionality, including any of the functionality described above and/or any additional functionality (including any functionality necessary to support the solution described above). The various types of network nodes may include components having the same physical hardware but configured (e.g., via programming) to support different radio access technologies, or may represent partly or entirely different physical components.

Although FIG. 7A illustrates network node 120 as a radio access node, LTE node 120a may be any suitable node associated with the LTE network. For example, in some embodiments, LTE node 120a may be a core network node that is associated with the LTE network and manages/monitors inactivity timer Tw. Thus, in certain embodiments, LTE node 120a may be configured without any transceiver 710. Similarly, Wi-Fi node 120b and legacy node 120c may be any suitable node associated with the Wi-Fi network and legacy network, respectively, such as any suitable radio access node or core network node.

FIG. 7B illustrates an example embodiment of a network node 120 that includes connection monitor 750 (which optionally includes inactivity timer Tw manager 755) and redirect module 760. The components of FIG. 7B may comprises any suitable hardware and/or software, such as any hardware and/or software described with respect to FIG. 7A.

If network node 120 is an LTE node 120a, connection monitor 750 determines that wireless device 110 is in radio resource control (RRC) idle mode and, in response, its inactivity timer manager 755 starts inactivity timer Tw. If connection monitor 750/inactivity timer Tw manager 755 determines that wireless device 110 has entered RRC connected mode prior to expiry of the inactivity timer Tw, inactivity timer Tw manager 755 stops the inactivity timer Tw and resets the inactivity timer Tw to its initial value, such as a value between 5 and 15 minutes. If connection monitor 750 later determines that wireless device 110 re-enters RRC idle mode, inactivity timer Tw manager 755 restarts the inactivity timer. If inactivity timer manger 755 detects expiry of inactivity timer Tw, it informs redirect module 760. Redirect module 760 then directs wireless device 110 to legacy node 120c. For example, redirect module 760 sends wireless device 110 a redirect message that includes a target frequency used by legacy node 120c.

If network node 120 is a legacy node 120c, connection monitor 750 may receive a radio resource control (RRC) connection request from wireless device 110. If the RRC connection request indicates inter radio access technology reselection as its cause, redirect module 760 does not direct wireless device 110 to LTE node 120a. If the RRC connection request indicates origination of packet data traffic as its cause, redirect module 760 directs wireless device 110 to LTE node 120a.

Modifications, additions, or omissions may be made to the systems and apparatuses disclosed herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions also may be made to the methods disclosed herein without departing from the scope of the disclosure. The methods may include more, fewer, or other steps. Additionally, steps may be performed in any suitable order.

Certain embodiments of the present disclosure may include one or more technical advantages. In some embodiments, overhead signaling on the LTE/IMS/EPC network may be reduced. For example, network resources may be optimized by moving idle users to a legacy radio access network. The optimized resources may allow for providing better throughput to active LTE data users. For example, resources that would otherwise be allocated to managing overhead signaling for idle devices may instead be allocated to active LTE data users. Some embodiments may include some, all, or none of these technical advantages. Other technical advantages may be readily ascertainable by one of ordinary skill in the art.

The above description of the embodiments does not constrain this disclosure. Other changes, substitutions, and alterations are possible without departing from the spirit and scope of this disclosure, as defined by the following claims.

What is claimed:

1. A long term evolution (LTE) node, operable to:
start an inactivity timer Tw in response to determining that a wireless device is in radio resource control (RRC) idle mode; and
direct the wireless device to a legacy node in response to expiry of the inactivity timer Tw.

2. The LTE node of claim 1, further operable to:
prior to expiry of the inactivity timer Tw, determine that the wireless device has entered RRC connected mode; and
stop the inactivity timer Tw in response to the wireless device having entered RRC connected mode.

3. The LTE node of claim 2, further operable to:
reset the inactivity timer Tw to its initial value; and
restart the inactivity timer in response to determining that the wireless device has entered RRC idle mode.

4. The LTE node of claim 1, wherein directing the wireless device to the legacy node comprises sending the wireless device a redirect message that includes a target frequency used by the legacy node.

5. The LTE node of claim 1, wherein the inactivity time Tw has an initial value between 5 and 15 minutes.

6. The LTE node of claim 1, wherein the legacy node uses one of the following radio access technologies: code division multiple access (CDMA), wideband CDMA (WCDMA), or global system for mobile communications (GSM).

7. A legacy node operable to:
receive a first radio resource control (RRC) connection request from a wireless device, the first RRC connection request indicating inter radio access technology reselection as its cause;
not direct the wireless device to a long term evolution (LTE) node in response to receiving the first RRC connection request;
receive a second RRC connection request from the wireless device, the second RRC connection request indicating origination of packet data traffic as its cause; and
direct the wireless device to the LTE node in response to receiving the second RRC connection request.

8. The legacy node of claim 7, further operable to connect a voice call for the wireless device after receiving the first RRC connection request and prior to receiving the second RRC connection request.

9. A method in a long term evolution (LTE) node for directing a wireless device to a legacy node, the method comprising:
starting an inactivity timer Tw in response to determining that the wireless device is in radio resource control (RRC) idle mode; and
directing the wireless device to the legacy node in response to expiry of the inactivity timer Tw.

10. The method of claim 9, further comprising:
prior to expiry of the inactivity timer Tw, determining that the wireless device has entered RRC connected mode; and
stopping the inactivity timer Tw in response to the wireless device having entered RRC connected mode.

11. The method of claim 10, further comprising:
resetting the inactivity timer Tw to its initial value; and
restarting the inactivity timer in response to determining that the wireless device has entered RRC idle mode.

12. The method of claim 9, wherein directing the wireless device to the legacy node comprises sending the wireless device a redirect message that includes a target frequency used by the legacy node.

13. The method of claim 9, wherein the inactivity time Tw has an initial value between 5 and 15 minutes.

14. The method of claim 9, wherein the legacy node uses one of the following radio access technologies: code division multiple access (CDMA), wideband CDMA (WCDMA), or global system for mobile communications (GSM).

15. A non-transitory computer-readable storage medium comprising logic, the logic, when executed by one or more processors, operable to:
start an inactivity timer Tw in response to determining that a wireless device is in radio resource control (RRC) idle mode; and
direct the wireless device to a legacy node in response to expiry of the inactivity timer Tw.

16. The non-transitory computer-readable storage medium of claim 15, the logic further operable to:
prior to expiry of the inactivity timer Tw, determine that the wireless device has entered RRC connected mode; and
stop the inactivity timer Tw in response to the wireless device having entered RRC connected mode.

17. The non-transitory computer-readable storage medium of claim 16, the logic further operable to:
reset the inactivity timer Tw to its initial value; and
restart the inactivity timer in response to determining that the wireless device has entered RRC idle mode.

18. The non-transitory computer-readable storage medium of claim 15, wherein directing the wireless device to the legacy node comprises sending the wireless device a redirect message that includes a target frequency used by the legacy node.

19. The non-transitory computer-readable storage medium of claim 15, wherein the inactivity time Tw has an initial value between 5 and 15 minutes.

20. The non-transitory computer-readable storage medium of claim 15, wherein the legacy node uses one of the following radio access technologies: code division multiple access (CDMA), wideband CDMA (WCDMA), or global system for mobile communications (GSM).
